(19) United States
(12) Patent Application Publication
(10) Pub. No.: US 2024/0275719 A1
(43) Pub. Date: Aug. 15, 2024

(54) MULTICAST DISTRIBUTION TREE SWITCHOVER IN HETEROGENEOUS PROVIDER EDGE ENVIRONMENTS

(71) Applicant: Cisco Technology, Inc., San Jose, CA (US)

(72) Inventors: Ramakrishnan Chokkanathapuram Sundaram, Cary, NC (US); Siva Ramamurthy, San Jose, CA (US); Stig I. Venaas, Oakland, CA (US)

(21) Appl. No.: 18/168,145

(22) Filed: Feb. 13, 2023

(51) Int. Cl. H04L 45/48; H04L 12/18; H04L 45/16

(52) U.S. Cl. CPC H04L 45/48; H04L 12/185; H04L 45/16

(57) ABSTRACT

In one aspect, a method includes discovering, by a first network router in a network of routers associated with a provider network, a network address translation service available at one or more second network routers, and selecting the network address translation service at one of the one or more second network routers, the network address translation service allowing the first network router to remain on a default Multicast Distribution Tree (MDT) while at least a number of the one or more second network routers receive data flows over a data MDT.

### FIELD OF THE TECHNOLOGY

The subject matter of this disclosure generally relates to the field of computer networks, and more particularly to multicast distribution tree (MDT) switchover in heterogeneous provider edge environments.

### BACKGROUND

Multicast is a popular feature used mainly by IP-networks of Enterprise customers. Multicast allows the efficient distribution of information between a single multicast source and multiple receivers. An example of a multicast source in a corporate network would be a financial information server provided by a third-party company such as Bloomberg's or Reuters. The receivers would be individual PCs scattered around the network all receiving the same financial information from the server. The multicast feature allows a single stream of information to be transmitted from a source device, regardless of how many receivers are active for the information from that source device. The routers automatically replicate a single copy of the stream to each interface where multicast receivers can be reached. Therefore, multicast significantly reduces the amount of traffic required to distribute information to many interested parties.

MDTs are multicast tunnels through the IP-network. MDTs transport customer multicast traffic encapsulated in GREs that are part of the same multicast domain. Different types of MDTs include default MDTs and data MDTs.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

In order to describe the manner in which the above-recited and other advantages and features of the disclosure can be obtained, a more particular description of the principles briefly described above will be rendered by reference to specific examples, which are illustrated in the appended drawings. Understanding that these drawings depict only exemplary examples of the disclosure and are not therefore to be considered to be limiting of its scope, the principles herein are described and explained with additional specificity and detail through the use of the accompanying drawings in which:

FIG. 1A illustrates an example cloud computing architecture according to some aspects of the present disclosure;

FIG. 1B illustrates an example fog computing architecture according to some aspects of the present disclosure

FIG. 2 depicts an exemplary schematic representation of a 5G network environment in which network slicing has been implemented according to some aspects of the present disclosure;

FIGS. 3A-3E illustrate example topologies of a provider network for multicast NAT service discovery according to some aspects of the present disclosure.

FIG. 4 illustrates an example process of NAT service utilization in a provider edge router environment according to some aspects of the present disclosure;

FIG. 5 illustrates an example of a computing system according to some aspects of the present disclosure; and

FIG. 6 illustrates an example network device according to some aspects of the present disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles can be used in the examples for convenience of a reader, which in no way should limit the scope of the disclosure. Unless otherwise defined, technical and scientific terms herein have the meaning commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### OVERVIEW

In a heterogeneous provider edge environment, there can be provider edge routers (PEs) with different capabilities with respect to hardware forwarding support, scale of decapsulation entries (VxLAN), or policy to remain in default MDT. In existing mechanism, when source PE meets the policy to cut over to data MDT or in case of instantaneous switch to data MDT, all receiver PE's with interest/capability are expected to join the new data MDT tree. If a receiver PE due to its capabilities or policy do not join the new tree, it will fail to receive the multicast flows as the flows are no longer flowing via default MDT.

The present disclosure is directed towards methods and techniques for allowing PEs that are not capable of moving to a data MDT, to remain in the default MDT and receive multicast flows. As will be described below, this designation can involve changing how a data MDT is joined by a receiver PE. Accordingly, multicast network access translation (NAT) services can be dynamically discovered and used to selectively and dynamically translate multicast streams towards the receiver PE.

In one aspect, a method includes discovering by a first network router in a network of routers associated with a provider network a network address translation service available at one or more second network routers; and selecting the network address translation service at one of the one or more second network routers, the network address translation service allowing the first network router to remain on a default Multicast Distribution Tree (MDT) while at least a number of the one or more second network routers receive data flows over a data MDT.

In another aspect, the discovering is based on a PIM flooding mechanism.

In another aspect, the network translation service is discovered in response to one or more probes initiated by the first network router.

In another aspect, the method further includes sending a request to the one or the one or more second network routers selected to install multicast network access translation entries.

In another aspect, the request is sent in a PIM join message.

In another aspect, the method further includes generating an entry at the first network router having a first component and a second component, the first component being an identification of the one of the one or more second network routers selected, the second component being a new group in SSM range to identify the entry.

In another aspect, the first network router is in a path of a third network router, the third network router receiving data flows over the data MDT.

In one aspect, a network device includes one or more memories having computer-readable instructions stored therein, and one or more processors. The one or more processors are configured to execute the computer-readable instructions to discover, by a first network router in a network of routers associated with a provider network, a network address translation service available at one or more second network routers, and select the network address translation service at one of the one or more second network routers, the network address translation service allowing the first network router to remain on a default Multicast Distribution Tree (MDT) while at least a number of the one or more second network routers receive data flows over a data MDT.

In one aspect, one or more non-transitory computer-readable media include computer-readable instructions, which when executed by one or more processors of a network appliance, cause the network appliance to discover, by a first network router in a network of routers associated with a provider network, a network address translation service available at one or more second network routers, and select the network address translation service at one of the one or more second network routers, the network address translation service allowing the first network router to remain on a default Multicast Distribution Tree (MDT) while at least a number of the one or more second network routers receive data flows over a data MDT.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

MDTs are multicast tunnels through a provider network (P-network). MDTs transport customer multicast traffic encapsulated in Generic Routing Encapsulations (GREs) that are part of the same multicast domain. Typically, MDTs can include a default MDT, and a data MDT. A default MDT is a distribution tree that connects all PEs, that include routers, and other network appliances. Multicast flows that propagate through a network over default MDT are received by all PEs even though there are no receivers. The default MDT is used to send low-bandwidth multicast traffic or traffic that is to be distributed to a set of receiver PEs.

Data MDT is a selective multicast tree that is joined by PE routers, that includes receiver interested in specific multicast flows. The Data MDT is an optimized tree, that is configured for a lower consumption of bandwidth. Data MDTs are used to tunnel high-bandwidth source traffic through the P-network to interested PE routers. Data MDTs provide the advantage of avoiding flooding of customer multicast traffic to all PE routers in a multicast domain.

In a heterogenous PE environment, there can be PEs with different capabilities with respect to hardware forwarding support, the scale of decapsulation entries (VxLAN), or policies to remain in default MDT. In some existing examples, when a source PE meets the policy to cut over to data MDT or in case of an instantaneous switch to data MDT, all receiver PEs with interest/capability are expected to join the new MDT tree. If a receiver PE, due to its capabilities or policy, does not join the new tree, the receiver PE will fail to receive the multicast flows as the flows will no longer be flowing via the default MDT.

The disclosed technology addresses the need in the art for designating PE network appliances to remain in default MDT, upon determining that the PE does not support a move to data MDT. As will be described below, this designation can involve changing how a data MDT tree is joined by a receiver PE. Accordingly, multicast network access translation (NAT) services can be dynamically discovered and used to selectively and dynamically translate multicast streams towards the receiver PE. Without this, multicast data traffic that flows over default MDT will be received by all PEs even though there may not be any compatible receiver PEs.

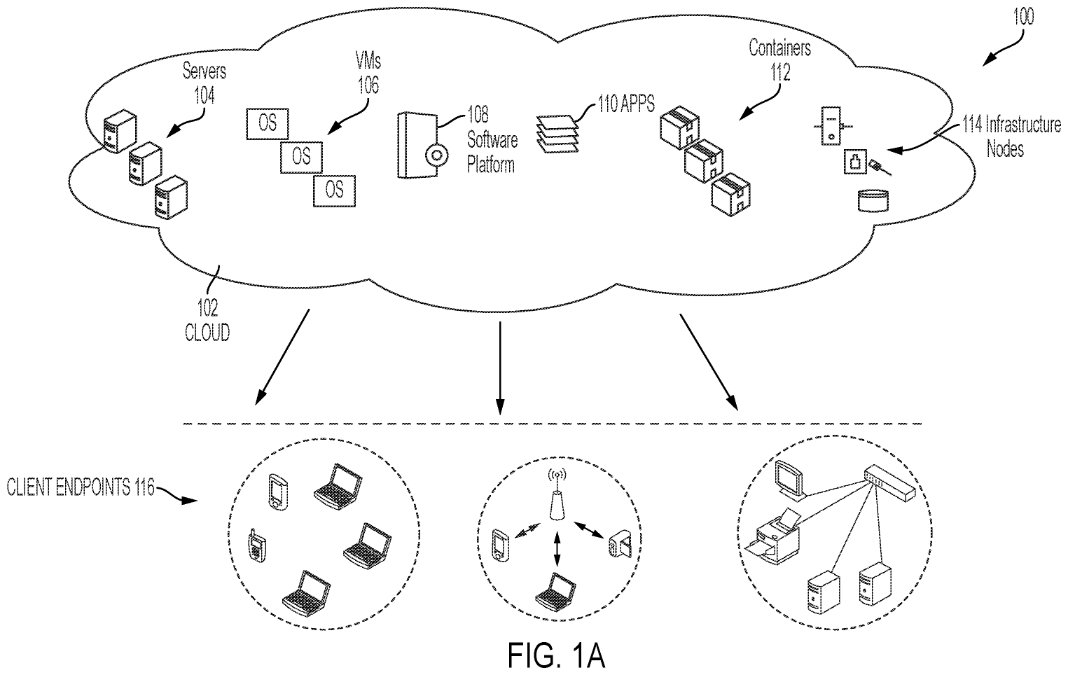

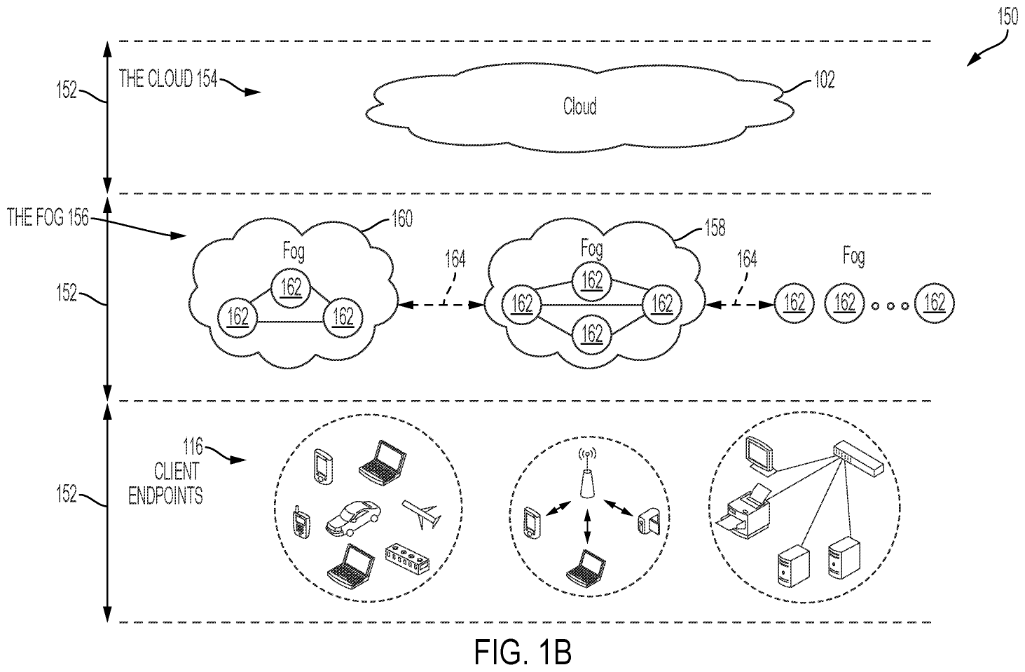

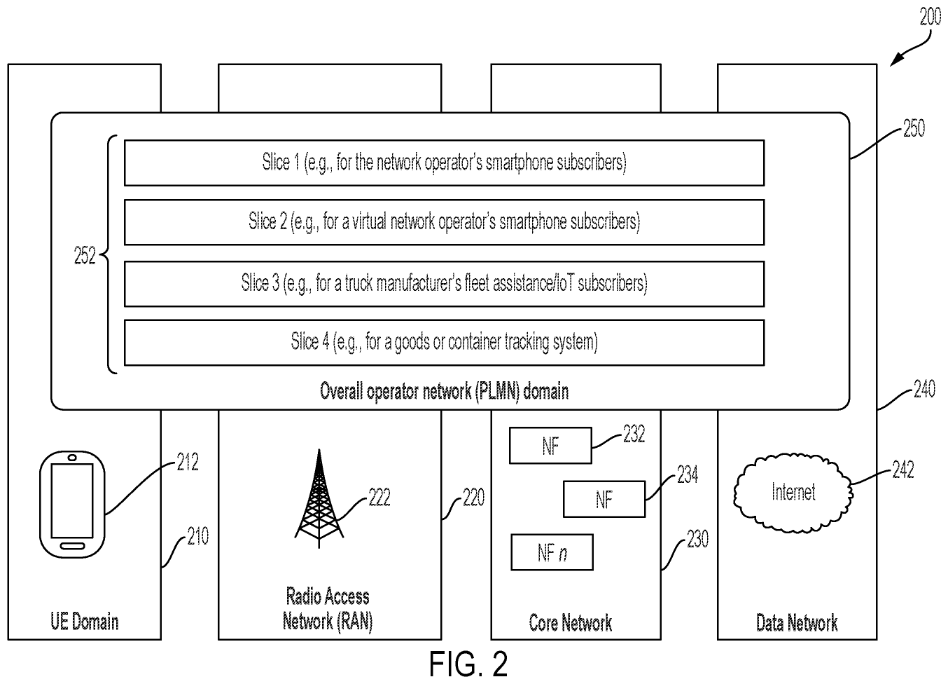

Prior to describing the proposed techniques and methods, example network environments and architectures for network data access and services, as illustrated in FIG. 1A, FIG. 1B, and FIG. 2 are described first.

FIG. 1A illustrates a diagram of an example cloud computing architecture according to some aspects of the present disclosure. The architecture 100 can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture according to some aspects of the present disclosure. The fog computing architecture 150 can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The fog computing architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 160 can be local or regional clouds or networks. For example, the fog instances 158, 160 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node can connect to a particular physical and/or logical connection point with the cloud layer 154 while located at the starting location and switch to a different physical and/or logical connection point with the cloud layer 154 while located at the destination location. The particular fog node can thus move within particular clouds and/or fog instances and, therefore, serve endpoints from different locations at different times.

FIG. 2 depicts an exemplary schematic representation of a 5G network environment in which network slicing has been implemented according to some aspects of the present disclosure. As illustrated, the network environment 200 is divided into four domains, each of which will be explained in greater depth below; a User Equipment (UE) domain 210, e.g. of one or more enterprise, in which a plurality of user cellphones or other connected devices 212 reside; a Radio Access Network (RAN) domain 220, in which a plurality of radio cells, base stations, towers, or other radio infrastructure 222 resides; a Core Network 230, in which a plurality of Network Functions (NFs) 232, 234, . . . , n reside; and a Data Network 240, in which one or more data communication networks such as the Internet 242 reside. Additionally, the Data Network 240 can support SaaS providers configured to provide SaaSs to enterprises, e.g. to users in the UE domain 210.

Core Network 230 contains a plurality of Network Functions (NFs), shown here as NF 232, NF 234 . . . NF n. In some examples, core network 230 is a 5G core network (5GC) in accordance with one or more accepted 5GC architectures or designs. In some examples, core network 230 is an Evolved Packet Core (EPC) network, which combines aspects of the 5GC with existing 4G networks. Regardless of the particular design of core network 230, the plurality of NFs typically execute in a control plane of core network 230, providing a service based architecture in which a given NF allows any other authorized NFs to access its services. For example, a Session Management Function (SMF) controls session establishment, modification, release, etc., and in the course of doing so, provides other NFs with access to these constituent SMF services.

In some examples, the plurality of NFs of core network 230 can include one or more Access and Mobility Management Functions (AMF; typically used when core network 230 is a 5GC network) and Mobility Management Entities (MME; typically used when core network 230 is an EPC network), collectively referred to herein as an AMF/MME for purposes of simplicity and clarity. In some examples, an AMF/MME can be common to or otherwise shared by multiple slices of the plurality of network slices 252, and in some examples an AMF/MME can be unique to a single one of the plurality of network slices 252.

The same is true of the remaining NFs of core network 230, which can be shared amongst one or more network slices or provided as a unique instance specific to a single one of the plurality of network slices 252. In addition to NFs comprising an AMF/MME as discussed above, the plurality of NFs of the core network 230 can additionally include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across these four domains of the 5G network environment 200, an overall operator network domain 250 is defined. The operator network domain 250 is in some examples a Public Land Mobile Network (PLMN), and can be thought of as the carrier or business entity that provides cellular service to the end users in UE domain 210. Within the operator network domain 250, a plurality of network slices 252 are created, defined, or otherwise provisioned in order to deliver a desired set of defined features and functionalities, e.g. SaaSs, for a certain use case or corresponding to other requirements or specifications. Note that network slicing for the plurality of network slices 252 is implemented in end-to-end fashion, spanning multiple disparate technical and administrative domains, including management and orchestration planes (not shown). In other words, network slicing is performed from at least the enterprise or subscriber edge at UE domain 210, through the Radio Access Network (RAN) 120, through the 5G access edge and the 5G core network 230, and to the data network 240. Moreover, note that this network slicing can span multiple different 5G providers.

For example, as shown here, the plurality of network slices 252 include Slice 1, which corresponds to smartphone subscribers of the 5G provider who also operates network domain, and Slice 2, which corresponds to smartphone subscribers of a virtual 5G provider leasing capacity from the actual operator of network domain 250. Also shown is Slice 3, which can be provided for a fleet of connected vehicles, and Slice 4, which can be provided for an IoT goods or container tracking system across a factory network or supply chain. Note that these network slices 252 are provided for purposes of illustration, and in accordance with the present disclosure, and the operator network domain 250 can implement any number of network slices, and can implement these network slices for purposes, use cases, or subsets of users and user equipment in addition to those listed above. Specifically, the operator network domain 250 can implement any number of network slices for provisioning SaaSs from SaaS providers to one or more enterprises.

5G mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous generation architectures.

Within the scope of the 5G mobile and wireless network architecture, a network slice comprises a set of defined features and functionalities that together form a complete Public Land Mobile Network (PLMN) for providing services to UEs. This network slicing permits for the controlled composition of a PLMN with the specific network functions and provided services that are required for a specific usage scenario. In other words, network slicing enables a 5G network operator to deploy multiple, independent PLMNs where each is customized by instantiating only those features, capabilities and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g. based on requirements of the services, to the enterprise.

Associating SaaSs and SaaS providers with network slices used to provide the SaaSs to enterprises can facilitate efficient management of SaaS provisioning to the enterprises. Specifically, it is desirable for an enterprise/subscriber to associate already procured SaaSs and SaaS providers with network slices actually being used to provision the SaaSs to the enterprise. However, associating SaaSs and SaaS providers with network slices is extremely difficult to achieve without federation across enterprises, network service providers, e.g., 5G service providers, and SaaS providers.

The disclosure now turns to a description of methods and techniques for designating PE network appliances to remain in default MDT upon determining that the PE does not support a switch to a data MDT.

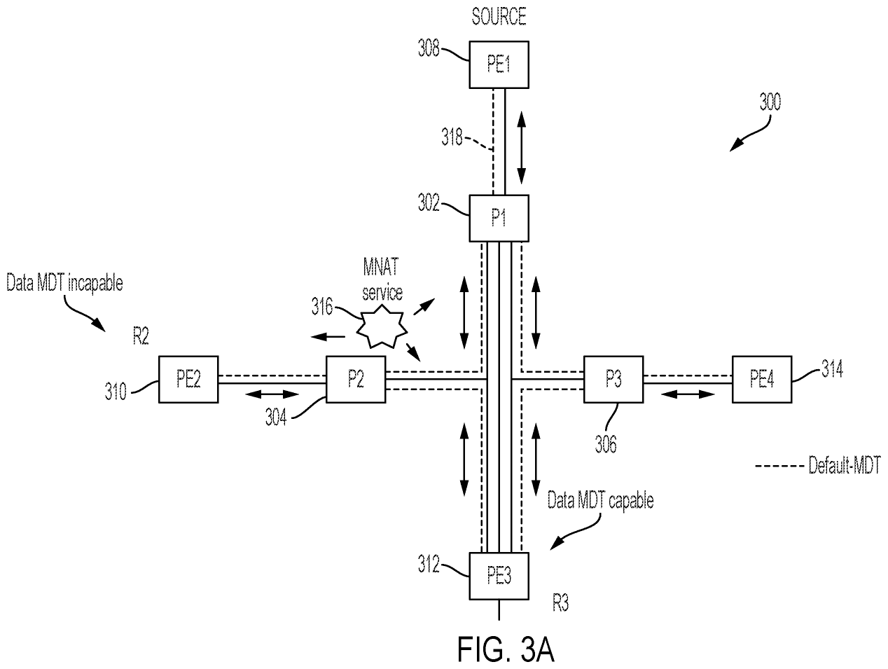

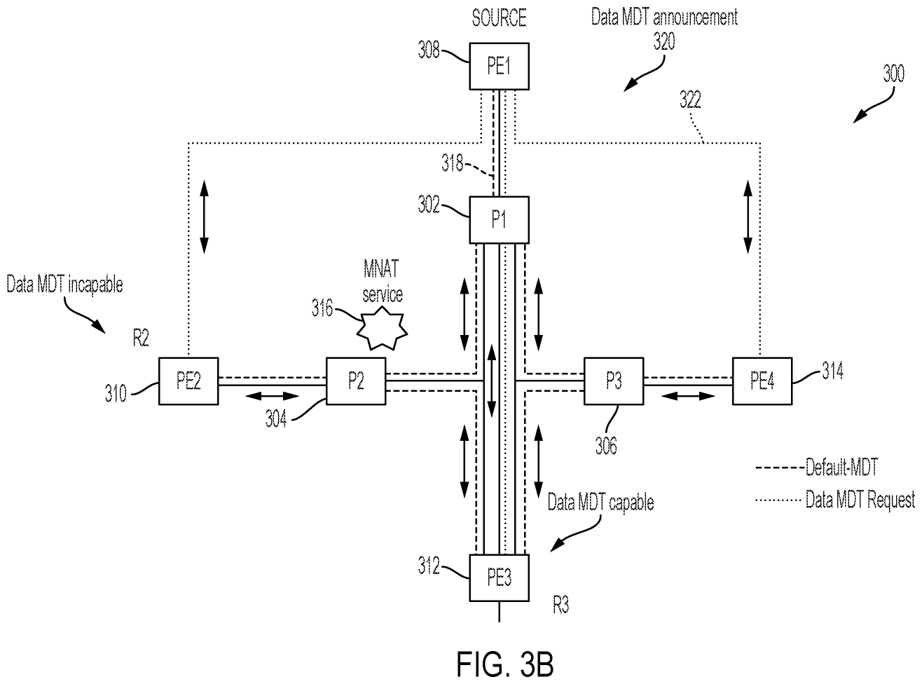

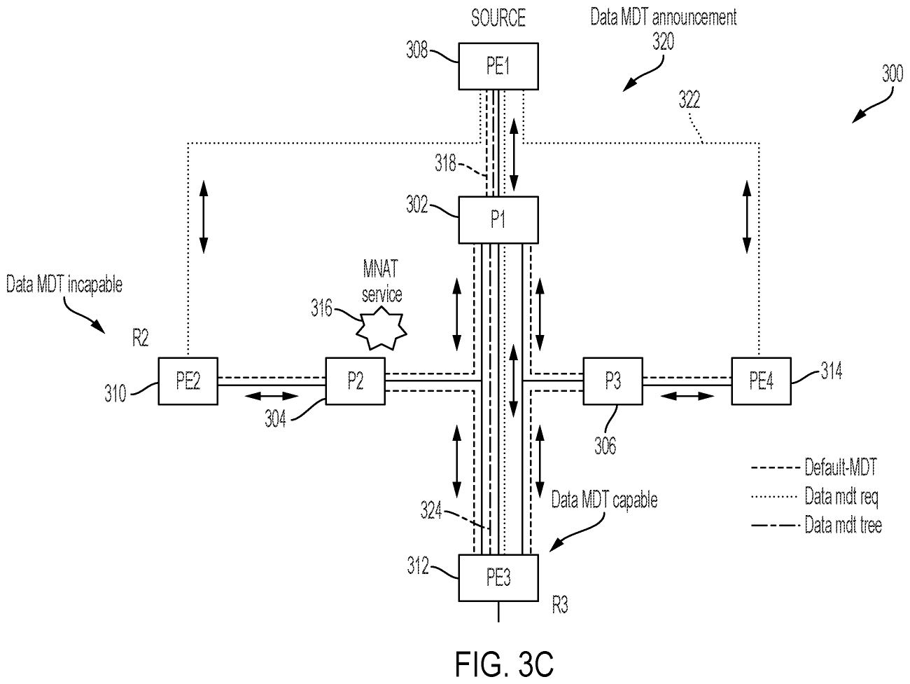

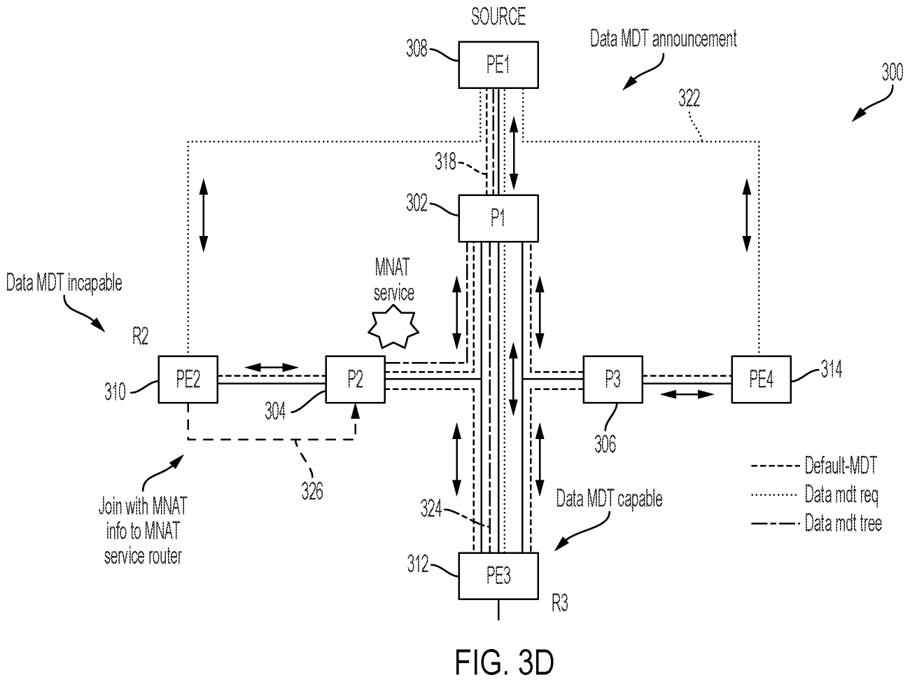

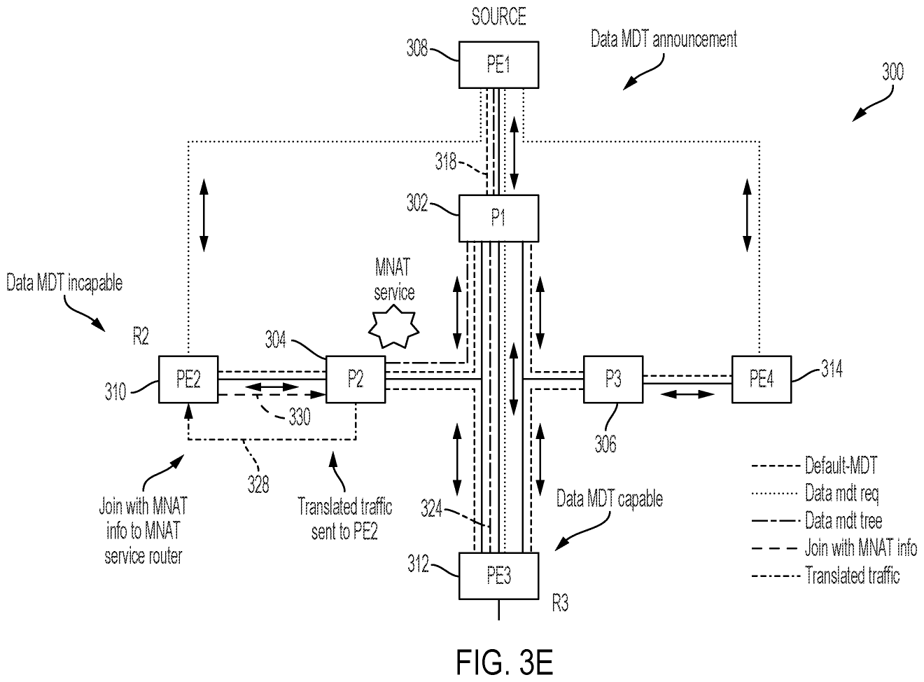

FIGS. 3A-3E illustrate example topologies of a provider network for multicast NAT service discovery according to some aspects of the present disclosure. As illustrated in FIGS. 3A-3E, a provider topology 300 (P topology 330) can include a plurality of provider network appliances such as a first provider network appliance (P1) 302, a second provider network appliance (P2) 304, and a third provider network appliance (P3) 306. The P topology 300 further incorporates a plurality of PE network appliances including a first PE network appliance (PE1) 308, a second PE network appliance (PE2) 310, a third PE network appliance (PE3) 312, and a fourth PE network appliance (PE4) 314. Provider network appliances and PE network appliances can be any type of known and/or to-be-developed network router, switch, gateway, etc.

In P topology 300 of FIG. 3A, traffic may initially flow over a default MDT 318. The P topology 300 as illustrated in FIG. 3A depicts a multicast NAT service discovery procedure where every receiver PE can discover a multicast NAT (MNAT) service that is available in the network.

In this example, PE1 308 is a multicast source network appliance, and PE2 310 and PE3 312 are receiver network appliances. Data traffic that is being transmitted from PE1 308, flows over the default MDT 318. The default MDT 318 is representative of the route that default traffic, including one or more data packets, can take in order to reach a destination P network appliance or PE network appliance such as PE2 310, PE3 312, etc. Such data packets can include any information such as controller information for one or more additional network appliances, etc.

FIG. 3A illustrates a scenario in which network traffic flows in a network having the P topology 300 according to a default MDT. In this scenario, a multicast NAT service router (e.g., P2 304) can be configured to send MNAT service information to other PE network appliances in the P topology 300 such as PE1 308, PE2 310, PE3 312, and PE4 314. Each PE, such as PE2 310 may request to join the default MDT and in response may choose the MNAT service offered by the closest PE, in this example P2 304. In the non-limiting example of FIG. 3A, PE2 310 can transmit an MNAT discovery message to discover nearby network appliances that provide MNAT services and in response can discover the P2 304 as the provider of the MNAT service 316. The MNAT discover message can enable PE2 310 to discover a loopback IP that is representative of the MNAT source (e.g., PE1 308) as well as capabilities thereof such as multicast-to-multicast, multicast-to-unicast, etc.

In some examples, the MNAT service discovery is initiated using a protocol-independent multicast (PIM) flooding mechanism that is advertised in a type, length, value (TLV) format. The information included in the TLV format may be the MNAT service 316 router details and supported NAT capabilities. The NAT capabilities of the MNAT service 316 can include the type of available/possible NAT services including, but not limited to, multicast to multicast, multicast to unicast.

The PIM flooding mechanism can be initiated by service routers that provide NAT services such as P2 304 shown in FIG. 3A. In response, receiver PEs, such as PE2 310, can choose to use a multicast NAT service provided by P2 304 that is closest to PE2 310. In some examples, redundancy can be achieved by using any cast NAT service routers, such as P1 302 and P3 306, that are configured with unicast and multicast capabilities.

In some examples, the MNAT service 316 can be initiated via received PE. In this instance, a receiver PE such as PE2 310 can send a probe to discover MNAT services in response to which NAT service routers (e.g., P2 304) can unicast the service availability to the PE2 310.

As illustrated in FIG. 3A, any traffic routed according to the default MDT 318 is distributed to each of P1 302, P2 304, P3 306, PE2 310, PE3 312, and PE4 314. In case of a switchover to a data MDT, oftentimes in high bandwidth applications, distributing traffic amongst all of the PEs can create flooding for dormant PEs, that are not data MDT capable.

Hereinafter, example embodiments are described whereby a data MDT incapable PE can “join” a data MDT by dynamically discovering and using multicast NAT services provided by one or more neighboring routers to selectively and dynamically translate multicast streams toward the data MDT incapable PE.

FIG. 3B illustrates an example of the P topology 300 for a data MDT join procedure in accordance with one example. In this example, a switchover to a data MDT may occur whereby a number of nodes in the network of P topology 300 are interested/capable of joining the data MDT while at least one PE is not (e.g., PE2 310).

In one example, a source node PE1 308 can transmit a data MDT announcement 320 to each of the other network appliances in the P topology 300. The data MDT announcement 320 can include a request 322 to join data MDT, which can be sent to each of P1 302, P2 304, P3 306, PE2 310, PE3 312, and PE4 314.

FIG. 3C illustrates an example of the P topology 300 where PE 3 312 joins the data MDT in response to the data MDT announcement 320 from the source network appliance PE1 308. The dynamic creation of the data MDT 324 can provide the advantage of dynamic switching from the default MDT 318 to the data MDT once traffic thresholds are exceeded on the default MDT 318. The creation of the data MDT 324 for data traffic can help ensure that all PE network appliances that are default MDT 318 capable can receive control information without interference from the data traffic.

As illustrated in FIG. 3B, PE3 312 is data MDT compatible making PE3 312 a network appliance capable of joining the data MDT and receiving network traffic according to the joined data MDT. However, PE2 310 is data MDT incapable and unable to receive data traffic over the data MDT. Thus, PE2 310 can perform a modified procedure for the P topology 300 to determine an alternative route for the PE2 310 to receive data traffic along with the MDT-capable network appliances. This procedure may be referred to as a modified NAT discovery procedure for data MDT incapable PEs.

In one non-limiting example of a modified NAT discovery procedure, PE2 310 can request the MNAT service 316 network appliance (e.g., P2 304) to install dynamic MNAT translation entries, where each of the entry details can be carried via a PIM join protocol with a target towards the MNAT service router P2 304. When P2 304 joins the data MDT, P2 304 can translate the data MDT traffic to the source and destination specified in the NAT rule provided in the dynamic NAT translation entries. The translation data MDT traffic is then sent to the PE2 310.

FIG. 3D illustrates an example of the P topology 300 where a data MDT incapable PE2 310 joins the data MDT via the selected P2 304.

In some examples, an entry is created at the receiver PE (e.g., PE2 310) per Virtual Private Network (VPN) Routing and Forwarding (VRF). The entry created can be a (S-NAT, G′), with S-NAT being a source network address translation of a source loopback of the NAT service router (e.g., P2 304) and G′ is a new group in a Source-Specific Multicast (SSM) range to identify the VRF. The S-NAT may be discovered via the NAT service discovery message while G′ can be G-def if G-def is SSM.

In the example of FIG. 3D, upon joining the data MDT 324, PE3 312 may transmit a PIM join to P2 304 for the MNAT service 316. The PIM join can include an MNAT translation to translate data traffic from the source network appliance (e.g., PE1 308) and the associated MDT group as it corresponds to the NAT service locator loopback 326 (e.g., an (S-NAT, G′)). Thereafter and as described above, PE2 310 can install a decap entry for the NAT service locator loopback 326 and the MNAT service 316.

In some examples, each (S-NAT, G′) entry is a one decap entry per VRF, which decapsulates the incoming traffic and determines a corresponding (CS, CG) entry to be forwarded to the intended recipient PE. Accordingly, decap entries can be more efficiently utilized as only one extra entry is used per VRF for all flows that do not want to switch to data MDT 324.

In some examples, if one PE is in the path of another PE which joins the data MDT (e.g., a data MDT capable PE to the left of data MDT incapable PE2 310), then a multicast entry may be created for the Data MDT group and source, but PE2 310 will not perform a decap. It will be just a regular multicast entry.

In some examples, if another receiver PE also discovers the same NAT router (e.g., P2 304) and doesn't want to join for data MDT for the corresponding default MDT, then the delivery is optimal with a multicast tree created for (S-NAT,G′), where G′ can be derived from the configuration.

Alternatively, a Multicast to unicast translation can be used from the NAT router (e.g., P2 304) to receiver PE (e.g., PE2 310) as well. Translation (S,Gmdt)⇒(S-NAT, Ud) where S-NAT is the NAT source and Ud is a unicast IP to identify VRF at the receiver PE. The (S-NAT,Ud) can be a decap entry, where after the decap traffic can flow to receiver PE.

The choice of using Multicast to multicast or multicast to unicast can be dynamic.

FIG. 3E illustrates an example of the P topology 300 for multicast to unicast translation of the MDT join procedure of a second source PE in accordance with one example. In this example, after the P2 304 installs the translations received from source PE1 308, the translated traffic (S-NAT, G′) 328 is sent to the PE2 310, which may then perform the decap and send the traffic to the corresponding customer VRF.

For example, when another source network appliance (e.g., S′) sends a request 322 to join the data MDT 324, and PE2 310 has receiver interest, PE2 310 can use the same MNAT service 316 by sending MNAT network information 330 to P2 304 in a PIM join. The (S-NAT, G′) entry may then be used to decap and deliver data from source S′ to the corresponding customer VRF.

In some examples, multicast to unicast translation can be used from a NAT router (e.g., P2 304) to receiver PE (e.g., PE2 310) as well. Translation (S-DATA,G-DATA) =>(S-NAT,Ud) where S-NAT is NAT source and Ud is a unicast IP to identify VRF at the receiver PE. The (S-NAT, Ud) may be a decap entry, and after decap, traffic will flow to the receiver PE.

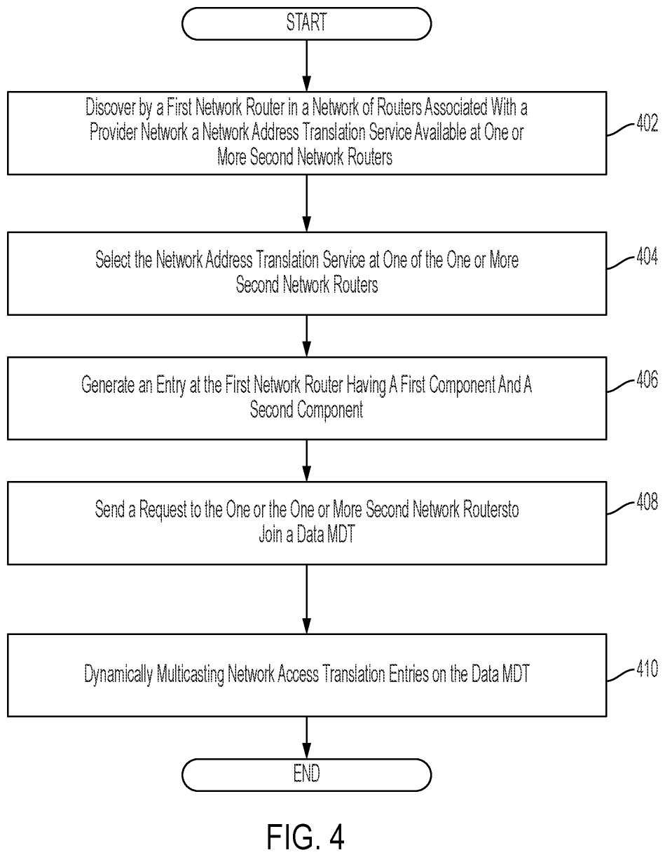

FIG. 4 illustrates an example process of NAT service utilization in a provider edge router environment according to some aspects of the present disclosure. Although the example method 400 depicts a particular sequence of operations, the sequence can be altered without departing from the scope of the present disclosure. For example, some of the operations depicted can be performed in parallel or in a different sequence that does not materially affect the function of method 400. In other examples, various components of an example device or system that implements method 400 can perform functions simultaneously or in a specific sequence.

In non-limiting example steps of FIG. 4, described below, an assumption is made that PE2 310 is a data MDT incapable PE, as described above with reference to FIGS. 3A-3E. However, the present disclosure is not limited thereto and any one or more of PEs such as those shown in P network 300 of FIGS. 3A-3E can be a data MDT incapable PE.

At step 402, a first network router (e.g., PE2 310) in a network of routers associated with a provider network (e.g., P network 300) can discover a network address translation service available at one or more second network routers (e.g., P2 304).

In some examples, the discovery is based on a PIM flooding mechanism or the source node sending the PIM. In some examples, the network translation service (e.g., MNAT service 316) is discovered in response to one or more probes initiated by the first network router PE2 310.

At step 404 a network address translation service (e.g., MNAT service 316) can be selected at one or more second network routers P2 304. For example, PE2 310, illustrated in FIG. 3A can select the network address translation service at P2 304. In some examples, the network address translation service (e.g., MNAT service 316) can allow (e.g., by performing steps 406, 408, and/or 410 described below) the first network router PE2 310 to remain on a default MDT 318 while at least a number of the one or more second network routers receive data flows over data MDT 324.

At step 406, the first network router (P2 304) can generate an entry having a first component and a second component. For example, P2 304, illustrated in FIG. 3A can generate an entry at the first network router PE2 310 having first and second components. In some examples, the first component identifies the one or more second network routers P2 304 selected. In some examples, the second component is a new group in the SSM range to identify the entry.

In some examples, the first network router, PE2 310 is in a path of a third network router P1 302, where the third network router can additionally receive data flows over the data MDT 324.

At step 408, a request to the one or more second network routers selected to install that are selected to install multicast network access translation entries, to join a data MDT 324. For example, PE1 308 illustrated in FIG. 3B can send a request to one or more second network routers to join the data MDT 324. In some examples, the request is sent in a PIM join message.

At step 410, network access translation entries can be dynamically multicast on the data MDT 324. For example, PE2 310 illustrated in FIG. 3E can dynamically multicast network access translation entries along the data MDT 324 data traffic route.

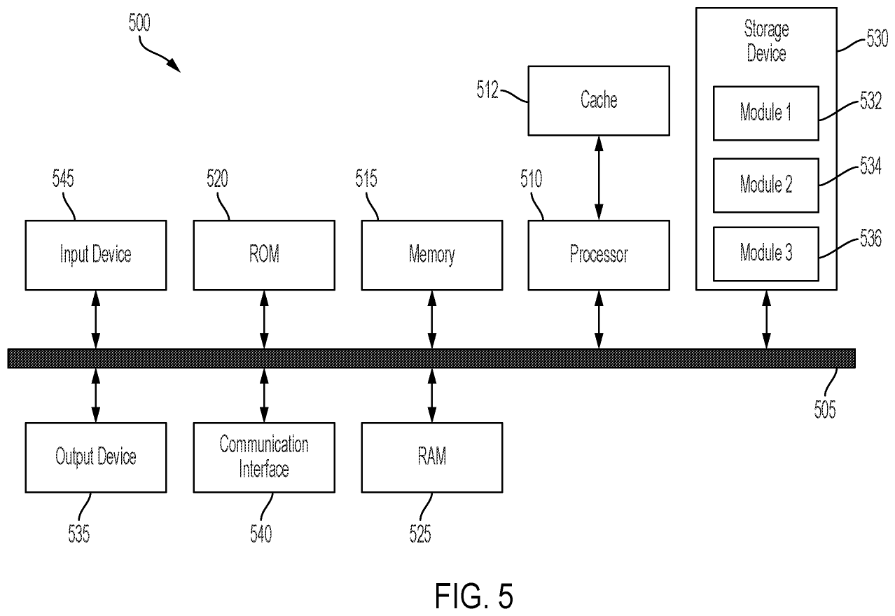

FIG. 5 shows an example of computing system 500, which can be for example any computing device that can perform functionalities of one or more network components described above (e.g., the provider network appliances 302, 304, 306, the PE network appliances 308, 310, 312, 314, etc.). Computing system 500 and/or any component thereof in which the components of the system are in communication with each other are configured to use connection 505 to communicate. Connection 505 can be a physical connection via a bus, or a direct connection into processor 510, such as in a chipset architecture. Connection 505 can also be a virtual connection, networked connection, or logical connection.

In some examples computing system 500 is a distributed system in which the functions described in this disclosure can be distributed within a data center, multiple data centers, a peer network, etc. In some examples, one or more of the described system components represents many such components each performing some or all of the function for which the component is described. In some examples, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 can essentially be a completely self-contained computing system, containing multiple cores or processors, a bus, memory controller, cache, etc. A multi-core processor can be symmetric or asymmetric.

To enable user interaction, computing system 500 includes an input device 545, which can represent any number of input mechanisms, such as a microphone for speech, a touch-sensitive screen for gesture or graphical input, a keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here can easily be substituted for improved hardware or firmware arrangements as they are developed.

Storage device 530 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., and when the code that defines such software is executed by the processor 510, it causes the system to perform a function. In some examples, a hardware service that performs a particular function can include the software component stored in a computer-readable medium in connection with the hardware components, such as processor 510, connection 505, output device 535, etc., to carry out the function.

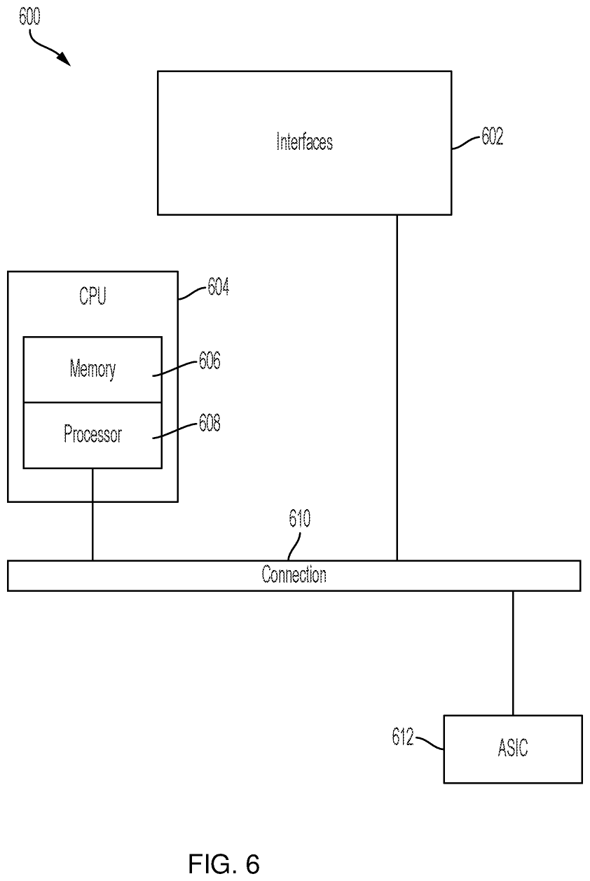

FIG. 6 illustrates an example network device 600 suitable for performing switching, routing, load balancing, and other networking operations. The example network device 600 can be implemented as switches, routers, nodes, metadata servers, load balancers, client devices, and so forth.

Network device 600 includes a central processing unit (CPU) 604, interfaces 602, and bus 610 (e.g., a PCI bus). When acting under the control of appropriate software or firmware, the CPU 604 is responsible for executing packet management, error detection, and/or routing functions. The CPU 604 preferably accomplishes all these functions under the control of software including an operating system and any appropriate applications software. CPU 604 can include one or more processors 608, such as a processor from the INTEL X86 family of microprocessors. In some cases, processor 608 can be specially designed hardware for controlling the operations of network device 600. In some cases, a memory 606 (e.g., non-volatile RAM, ROM, etc.) also forms part of CPU 604. However, there are many different ways in which memory could be coupled to the system.

The interfaces 602 are typically provided as modular interface cards (sometimes referred to as “line cards”). Generally, they control the sending and receiving of data packets over the network and sometimes support other peripherals used with the network device 600. Among the interfaces that can be provided are Ethernet interfaces, frame relay interfaces, cable interfaces, DSL interfaces, token ring interfaces, and the like. In addition, various very high-speed interfaces can be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces can include ports appropriate for communication with the appropriate media. In some cases, they can also include an independent processor and, in some instances, volatile RAM. The independent processors can control such communications-intensive tasks as packet switching, media control, signal processing, crypto processing, and management. By providing separate processors for the communication-intensive tasks, these interfaces allow the master CPU (e.g., 604) to efficiently perform routing computations, network diagnostics, security functions, etc.

Although the system shown in FIG. 6 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 600.

Regardless of the network device's configuration, it can employ one or more memories, or memory modules (including memory 606) configured to store program instructions for the general-purpose network operations and mechanisms for roaming, route optimization, and routing functions described herein. The program instructions can control the operation of an operating system and/or one or more applications, for example. The memory or memories can also be configured to store tables such as mobility binding, registration, and association tables, etc. Memory 606 could also hold various software containers and virtualized execution environments and data.

The network device 600 can also include an application-specific integrated circuit (ASIC), which can be configured to perform routing and/or switching operations. The ASIC can communicate with other components in the network device 600 via bus 610, to exchange data and signals and coordinate various types of operations by the network device 600, such as routing, switching, and/or data storage operations, for example.

For clarity of explanation, in some instances, the various examples can be presented as individual functional blocks comprising devices, device components, steps or routines in a method embodied in software, or combinations of hardware and software.

In some examples, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take various form factors. Some examples of such form factors include general-purpose computing devices such as servers, rack mount devices, desktop computers, laptop computers, and so on, or general-purpose mobile computing devices, such as tablet computers, smartphones, personal digital assistants, wearable devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A method comprising:
discovering by a first network router in a network of routers associated with a provider network a network address translation service available at one or more second network routers; and
selecting the network address translation service at one of the one or more second network routers, the network address translation service allowing the first network router to remain on a default Multicast Distribution Tree (MDT) while at least a number of the one or more second network routers receive data flows over a data MDT.

2. The method of claim 1, wherein the discovering is based on a PIM flooding mechanism.

3. The method of claim 1, wherein the network translation service is discovered in response to one or more probes initiated by the first network router.

4. The method of claim 1, further comprising:
sending a request to the one or the one or more second network routers selected to install multicast network access translation entries.

5. The method of claim 4, wherein the request is sent in a PIM join message.

6. The method of claim 1, further comprising:
generating an entry at the first network router having a first component and a second component, the first component being an identification of the one of the one or more second network routers selected, the second component being a new group in SSM range to identify the entry.

7. The method of claim 1, wherein the first network router is in a path of a third network router, the third network router receiving data flows over the data MDT.

8. A network device comprising:
one or more memories having computer-readable instructions stored therein; and
one or more processors configured to execute the computer-readable instructions to:
discover, by a first network router in a network of routers associated with a provider network, a network address translation service available at one or more second network routers; and
select the network address translation service at one of the one or more second network routers, the network address translation service allowing the first network router to remain on a default Multicast Distribution Tree (MDT) while at least a number of the one or more second network routers receive data flows over a data MDT.

9. The network device of claim 8, the discovering is based on a PIM flooding mechanism.

10. The network device of claim 8, the network translation service is discovered in response to one or more probes initiated by the first network router.

11. The network device of claim 8, wherein the instructions further cause the processor to:
send a request to the one or the one or more second network routers selected to install multicast network access translation entries.

12. The network device of claim 11, the request is sent in a PIM join message.

13. The network device of claim 8, wherein the instructions further cause the processor to:
generate an entry at the first network router having a first component and a second component, the first component being an identification of the one of the one or more second network routers selected, the second component being a new group in SSM range to identify the entry.

14. The network device of claim 8, the first network router is in a path of a third network router, the third network router receiving data flows over the data MDT.

15. A non-transitory computer-readable medium comprising computer-readable instructions, which when executed by one or more processors of a network appliance, cause the network appliance to:
discover, by a first network router in a network of routers associated with a provider network, a network address translation service available at one or more second network routers; and
select the network address translation service at one of the one or more second network routers, the network address translation service allowing the first network router to remain on a default Multicast Distribution Tree (MDT) while at least a number of the one or more second network routers receive data flows over a data MDT.

16. The non-transitory computer-readable medium of claim 15, wherein the discovering is based on a PIM flooding mechanism.

17. The non-transitory computer-readable medium of claim 15, wherein the network translation service is discovered in response to one or more probes initiated by the first network router.

18. The non-transitory computer-readable medium of claim 15, wherein the computer-readable medium further comprises instructions that, when executed by the network appliance, cause the network appliance to:
send a request to the one or the one or more second network routers selected to install multicast network access translation entries.

19. The non-transitory computer-readable medium of claim 18, wherein the request is sent in a PIM join message.

20. The non-transitory computer-readable medium of claim 15, wherein the computer-readable medium further comprises instructions that, when executed by the network appliance, cause the network appliance to:
generate an entry at the first network router having a first component and a second component, the first component being an identification of the one of the one or more second network routers selected, the second component being a new group in SSM range to identify the entry.
